(19) United States
(12) Patent Application Publication
(10) Pub. No.: US 2007/0289415 A1
(43) Pub. Date: Dec. 20, 2007

(54) Spanner with protruding patterns on the handle

(76) Inventor: Chih-Ching Hsieh, Taichung (TW)

Correspondence Address: Chih-Ching Hsiehe, 235 Chung-Ho, Box 8-24, Taipei, TW

(21) Appl. No.: 11/455,923

(22) Filed: Jun. 20, 2006

(51) Int. Cl. B25B 23/16; B25G 1/00

(52) U.S. Cl. 81/177.1

(57) ABSTRACT

A spanner has a handle, the handle having two opposite convex cambered surfaces between two narrow opposite surfaces; at least one convex cambered surface being formed with protruding pattern. The protruding pattern is protruding character which are used to indicate the size of the spanner or the trademark of the spanner. The protruding patterns are at two opposite convex cambered surfaces so as to have an effect of slideproof. The edges of the protruding pattern are cambered edges. Height of the protruding pattern is from 0.4 mm to 0.6 mm.

### FIELD OF THE INVENTION

The present invention relates to spanners, and in particular to a spanner with protruding patterns on the handle thereof.

### BACKGROUND OF THE INVENTION

In the prior art spanner, the handle thereof has two types, one has flat surfaces and the other has convex cambered surfaces.

Referring to FIGS. 1 and 2, the prior art spanner is illustrated, wherein concave characters 12 are formed on the handle 11 of the spanner 10. Because the characters are concave, dirt will accumulate in the concave portions. Furthermore, it is difficult to electroplate on the characters.

Referring to FIGS. 3 and 4, in this prior art, a recess area 22 is formed in the handle 21 of the spanner 20. Protruding characters are formed on the recess area. However in this prior art, it is difficult to from the protruding characters because the mold is difficult to pull out from protruding characters. Furthermore, for a long time, the protruding characters will wear so that it is difficult to identify the protruding characters.

### SUMMARY OF THE INVENTION

Accordingly, the primary object of the present invention is to provide a spanner with protruding patterns on the handle thereof.

To achieve above objects, the present invention provides a spanner which has a handle, the handle having two opposite convex cambered surfaces between two narrow opposite surfaces; at least one convex cambered surface being formed with a protruding pattern. The protruding pattern is protruding characters which are used to indicate the size of the spanner or the trademark of the spanner. The protruding patterns are at two opposite convex cambered surfaces so as to have an effect of slideproof. The edges of the protruding pattern are cambered edges. Height of the protruding pattern is from 0.4 mm to 0.6 mm.

The various objects and advantages of the present invention will be more readily understood from the following detailed description when read in conjunction with the appended drawing.

### BRIEF DESCRIPTION OF THE DRAWINGS

FIG. 1 is a schematic view of a prior art spanner.

FIG. 2 is a partial enlarged view of the prior art spanner.

FIG. 3 is a schematic view of another prior art spanner.

FIG. 4 is a partial enlarged view of the another prior art spanner.

FIG. 5 is a schematic view of the spanner of the present invention.

FIG. 6 is a partial enlarged view of the spanner of the present invention.

FIG. 7 is a cross sectional view along line AB of FIG. 6, where only one side of the handle has protruding characters.

FIG. 8 is a cross sectional view along line AB of FIG. 6, where two sides of the handle have protruding characters.

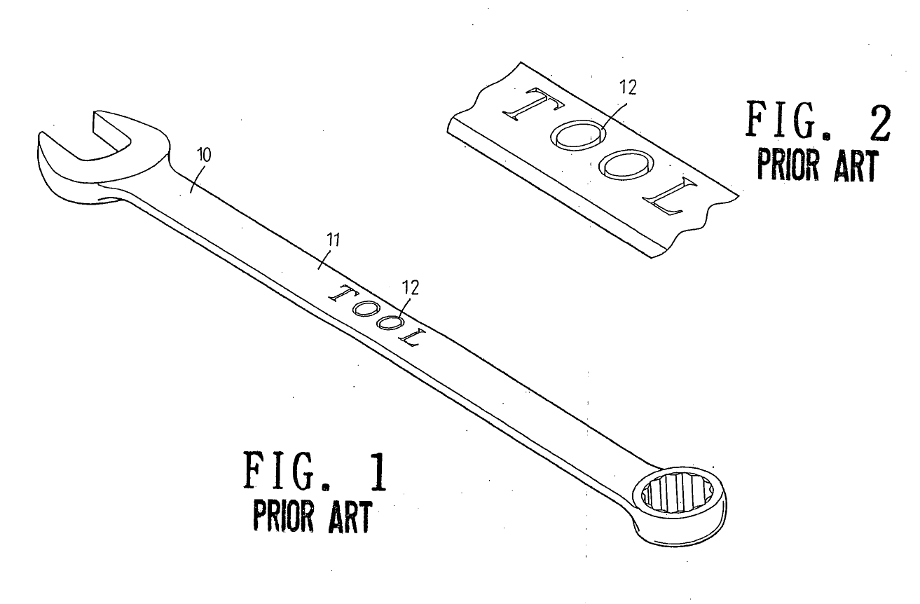

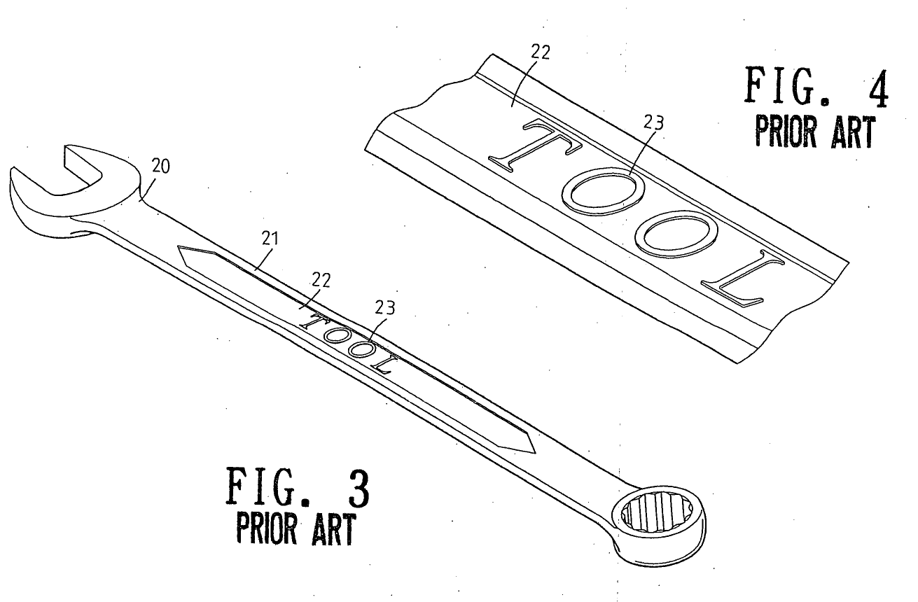

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

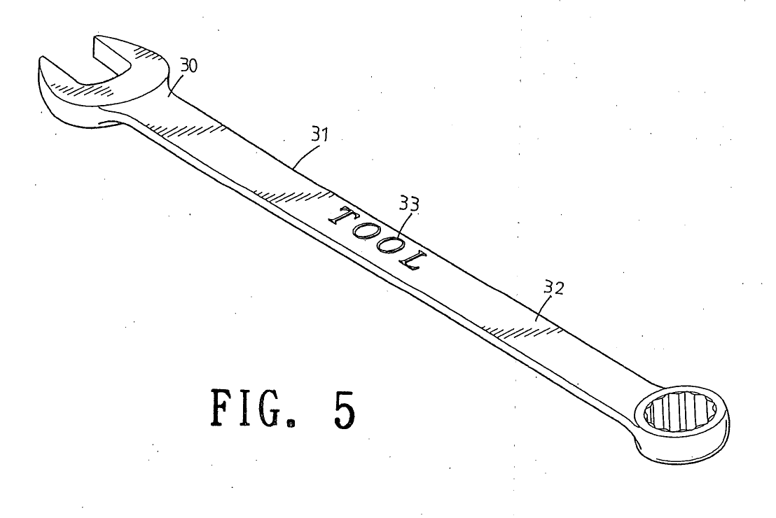

Referring to FIGS. 5 and 6, the spanner with protruding pattern according to the present invention is illustrated. The present invention has the following elements.

A handle 31 of a spanner 30 has two opposite convex cambered surfaces 32 between two narrow opposite surfaces. At least one convex cambered surface 32 is formed with protruding patterns 33.

The design of the convex cambered surfaces 32 makes the user feel easy and comfortable. The protruding pattern 33 may be the size of the spanner or a trademark. Other than being identified by eyes, the protruding pattern 33 has the advantage of being identified in dark by the holding of the hands.

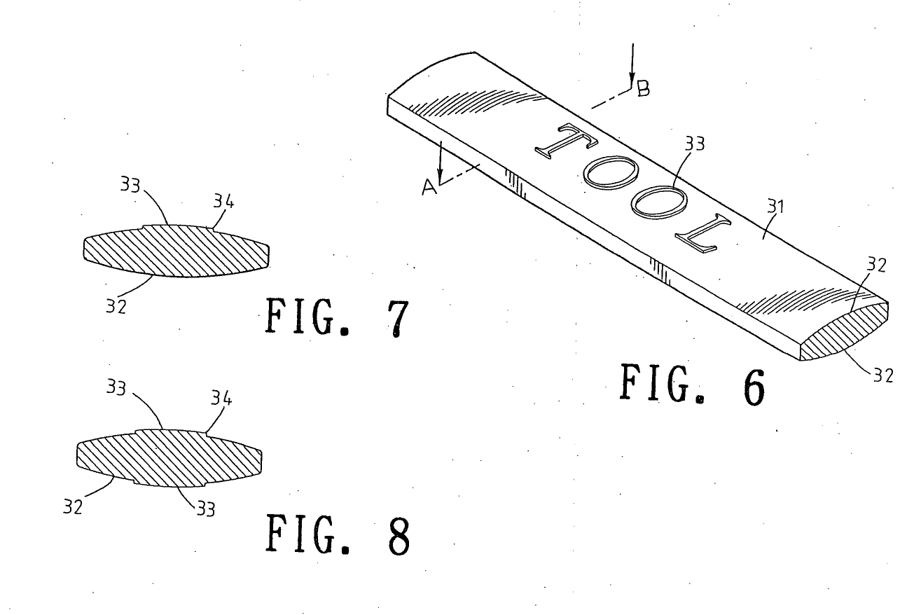

With reference to FIGS. 6 and 7, the protruding pattern 33 of the present invention on the convex cambered surface 32 can be formed by punching, which is easier than those used in the prior art of punching words in a recess area.

Furthermore, the protruding pattern 33 can be identified easily by hands.

Referring to FIG. 8, in this embodiment, the protruding pattern 33 is formed on the two convex cambered surfaces 32. This design has the effect of slide-proof.

The designs in FIGS. 7 and 8 have the effect of enlarging the width of the handle 31 so as to increase the strength of the spanner 30. However the prior art has no this effect.

The edges 34 of the protruding pattern 33 are cambered edges which provide preferred touch feeling to users. Preferably, the height of the protruding pattern 33 is ranged from 0.4 mm to 0.6 mm.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A spanner having a handle, the handle having four sides; two narrow flat sides at opposite sides; and two opposite convex cambered sides between two narrow opposite sides; each convex cambered side is uniquely formed by one cambered surface; and at least one convex cambered surface being formed with a protruding pattern.

2. The spanner as claimed in claim 1, wherein the protruding pattern is protruding character which are used to indicate the size of the spanner or the trademark of the spanner.

3. The spanner as claimed in claim 1, wherein the protruding patterns are formed at two opposite convex cambered surfaces so as to have an effect of slideproof.

4. The spanner as claimed in claim 1, wherein the edges of the protruding pattern are cambered edges.

5. The spanner as claimed in claim 1, wherein height of the protruding pattern is ranged from 0.4 mm to 0.6 mm.

6-7. (canceled)
